(19) United States
(12) Patent Application Publication
(10) Pub. No.: US 2023/0332004 A1
(43) Pub. Date: Oct. 19, 2023

(54) Radiation-Curable Ink Jet Composition And Printing Method

(71) Applicant: SEIKO EPSON CORPORATION, Tokyo (JP)

(72) Inventors: Kyohei TANAKA, Matsumoto (JP); Keitaro NAKANO, Matsumoto (JP); Midori SEKINE, Matsumoto (JP)

(21) Appl. No.: 18/341,127

(22) Filed: Jun. 26, 2023

Related U.S. Application Data
(63) Continuation of application No. 16/902,426, filed on Jun. 16, 2020.

(30) Foreign Application Priority Data
Jun. 17, 2019 (JP) 2019-111795

(51) Int. Cl. C09D 11/101; C09D 11/38; B41M 5/00; C09D 11/107; C09D 11/322

(52) U.S. Cl. CPC C09D 11/101; B41M 5/0023; C09D 11/107; C09D 11/322; C09D 11/38; C08K 5/45

(57) ABSTRACT

A radiation-curable ink jet composition that is a white ink containing a white coloring material or a pale or clear ink containing 1.2% by mass or less of a coloring material contains at least one polymerizable compound including at least one of a monofunctional monomer having a nitrogen-containing heterocyclic structure and a monomer having a hydroxy group. In the composition, the thioxanthone-based photopolymerization initiator content is limited to 0.3% or less relative to the total mass of the radiation-curable ink jet composition.

This application is a continuation of U.S. Pat. Application No. 16/902,426 filed Jun. 16, 2020, which is based on, and claims priority from JP Application Serial Number 2019-111795, filed Jun. 17, 2019, the disclosures of which are hereby expressly incorporated by reference herein in their entireties.

### BACKGROUND

### 1. Technical Field

The present disclosure relates to a radiation-curable ink jet composition and a printing method.

### 2. Related Art

For example, JP-A-2012-162688 discloses a photo-curable ink jet ink composition containing, by mass, 40% to 75% of (meth)acrylic ester having a vinyl ether group, 1% to 20% of urethane-(meth)acrylate oligomer, and a photopolymerization initiator. This photo-curable ink jet ink composition is highly reactive and not viscous but can produce printed items of which the ink coating exhibits excellent characteristics, particularly, in terms of flexibility. A radiation-curable ink jet composition disclosed in JP-A-2018-9142 is less odor and highly curable, and the cured product of which is flexible. This composition contains a (meth)acrylic ester having a vinyl ether group, acryloylmorpholine or similar compound, and vinylcaprolactam or similar compound.

The photo-curable or radiation-curable ink jet compositions as cited above often contain a thioxanthone-based photopolymerization initiator because thioxanthone-based photopolymerization initiators are not subject to oxygen inhibition and accordingly can improve the curability of the ink composition. It has however been found that the thioxanthone-based photopolymerization initiator causes the ink coating to discolor conspicuously if used in specific conditions.

### SUMMARY

Accordingly, the present disclosure provides a radiation-curable ink jet composition that is a white ink containing a white coloring material or a pale or clear ink containing 1.2% by mass or less of a coloring material. The radiation-curable ink jet composition contains at least one polymerizable compound including at least one of a monofunctional monomer having a nitrogen-containing heterocyclic structure and a monomer having a hydroxy group and in which the thioxanthone-based photopolymerization initiator content is limited to 0.3% or less relative to the total mass of the radiation-curable ink jet composition.

The radiation-curable ink jet composition may further contain an acylphosphine oxide-based photopolymerization initiator in a proportion of 10% or less relative to the total mass of the radiation-curable ink jet composition.

In the radiation-curable ink jet composition, the monofunctional monomer having a nitrogen-containing heterocyclic structure may include acryloylmorpholine.

In the radiation-curable ink jet composition, the content of the monofunctional monomer having a nitrogen-containing heterocyclic structure may be 3.0% to 15% relative to the total mass of the radiation-curable ink jet composition.

The at least one polymerizable compound may include a (meth)acrylate having a crosslinked condensed ring structure.

In the radiation-curable ink jet composition, the (meth)acrylate having a crosslinked condensed ring structure may include dicyclopentenyl (met)acrylate.

The at least one polymerizable compound may include a monofunctional urethane acrylate.

The monofunctional urethane acrylate may be represented by the following formula (1):

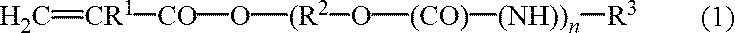

wherein R¹ represents a hydrogen atom or a methyl group, R² represents a divalent organic residue having a carbon number of 2 to 5, R³ represents an alkyl group having a carbon number of 1 to 10 or a hydroxyalkyl group having a carbon number of 1 to 10, and n represents an integer of 1 or more.

In the radiation-curable ink jet composition, the at least one polymerizable compound may include a (meth)acrylic ester having a vinyl ether group, represented by the following formula (2):

CH₂═CR⁴—COOR⁵—O—CH═CH—R⁶, wherein R⁴ represents a hydrogen atom or a methyl group, R⁵ represents a divalent organic residue having a carbon number of 2 to 20, and R⁶ represents a hydrogen atom or a monovalent organic residue having a carbon number of 1 to 11. In this instance, the (meth)acrylic ester content is 1.0% to 10% relative to the total mass of the radiation-curable ink jet composition.

In the radiation-curable ink jet composition, the white coloring material content may be 15% or more relative to the total mass of the radiation-curable ink jet composition.

In the radiation-curable ink jet composition, the at least one polymerizable compound may include at least one monofunctional monomer in a proportion of 90% or more to the total mass of the polymerizable compounds.

In the radiation-curable ink jet composition, the coloring material of the pale or clear ink may be one of a cyan coloring material and a magenta coloring material.

The present disclosure is also directed to a printing method including an ejection step of ejecting the above-described radiation-curable ink jet composition from an ink jet head to apply the composition onto a printing medium, and an irradiation step of irradiating the radiation-curable ink jet composition on the printing medium with radiation.

### DESCRIPTION OF EXEMPLARY EMBODIMENTS

Some embodiments of the subject matter of the present disclosure will now be described. However, the implementation of the subject matter is not limited to the disclosed embodiments, and various modifications may be made without departing from the scope and spirit of the present disclosure.

In the description disclosed herein, “(meth)acryloyl” refers to at least either acryloyl or methacryloyl; “(meth)acrylate” refers to at least either an acrylate or the corresponding methacrylate; and a “(meth)acrylic” compound refers to at least either an acrylic compound or the corresponding methacrylic compound.

### 1. Radiation-Curable Ink Jet Composition

The radiation-curable ink jet composition (hereinafter often referred to as the composition)disclosed herein is either a white ink containing a white coloring material or a pale or clear ink containing 1.2% by mass or less of a coloring material. The radiation-curable ink jet composition contains one or more polymerizable compounds including at least one of a nitrogen-containing heterocyclic structure and a monomer having a hydroxy group, and in which the thioxanthone-based photopolymerization initiator content is limited to 0.3% or less relative to the total mass of the radiation-curable ink jet composition.

The reason for the above-mentioned discoloration is probably, but not limited to, that the thioxanthone-based photopolymerization initiator abstracts protons from a monofunctional monomer having a nitrogen-containing heterocyclic structure or a monomer having a hydroxy group and bind with the protons, thus yellowing the coating. Monofunctional monomers having a nitrogen-containing heterocyclic structure, such as acryloylmorpholine and n-vinylcaprolactam, have positive charge localized at the nitrogen atom, and the hydrogen atom of the alkyl group adjacent to the nitrogen atom is easily abstracted by the thioxanthone-based photopolymerization initiator, thereby causing discoloration. Similarly, monomers having a hydroxy group, such as 4-hydroxybutyl acrylate, tend to undergo proton abstraction. However, the homopolymers of a monofunctional monomer having a nitrogen-containing heterocyclic structure or a monomer having a hydroxy group have a high glass transition temperature Tg and are, accordingly, useful in forming flexible and adhesive coatings resistant to rubbing.

While the discoloration caused by the thioxanthone-based photopolymerization initiator is less likely to be a problem with deep color inks, the discoloration can be a cause of degradation in color reproduction of pale or clear inks containing merely a small amount or not containing of coloring material or white inks.

The concept of the present disclosure is that the discoloration of ink coatings is reduced by limiting the thioxanthone-based photopolymerization initiator content to a specific range in a composition containing as a polymerizable compound at least one of a monofunctional monomer having a nitrogen-containing heterocyclic structure and a monomer having a hydroxy group.

The radiation-curable ink jet composition according to the embodiments of the present disclosure is used by being ejected from an ink jet head by an ink jet method. Although the radiation-curable ink jet composition of the embodiment disclosed herein is an ink composition, the radiation-curable ink jet composition of an embodiment may be used for three-dimensional (3D) fabrication in an embodiment without being limited to an ink composition.

The radiation-curable ink jet composition is cured by being irradiated with radiation. Radiation may be ultraviolet (UV) light, an electron beam, infrared (IR) light, visible light, or X rays. UV light is beneficial as the radiation from the viewpoint of prevalence thereof and availability of radiation sources and materials that can be cured therewith.

The constituents of a radiation-curable ink jet composition according to an embodiment will now be described.

### 1. 1. Coloring Material

The radiation-curable ink jet composition is a white ink containing a white coloring material or a pale or clear ink containing 1.2% by mass or less of coloring material. The coloring material may be at least one of a pigment and a dye. The coloring material used in the pale or clear ink, that is the coloring material other than the white coloring material, may be, but is not limited to, a cyan coloring material or a magenta coloring material and may be selected from the materials cited later herein. The concept of the present disclosure can be embodied effectively in white inks, clear inks, cyan inks, and magenta inks because discoloration of the coatings of such inks is conspicuous.

For the white ink, the white coloring material content may be 10% or more, for example, 15% or more, relative to the total mass of the composition. The white ink containing 10% by mass or more of white coloring material is likely to increase opacity. Also, the white coloring material content in the white ink may be 30% or less, for example, 25% or less or 20% or less, relative to the total mass of the composition. The coating of the white ink containing 30% by mass or less of white coloring material is likely to be adhesive and flexible.

For the pale ink, the coloring material content may be 1.2% or less, for example, 1.0% or less, 0.90% or less, or 0.70% or less, relative to the total mass of the composition. In this instance, the lower limit of the coloring material may be, but is not limited to, 0.05% or more, for example, 0.1% or more, 0.2% or more, or 0.5% or more, relative to the total mass of the aqueous ink composition. For the clear ink, the coloring material content may be 0.05% or less, for example, 0.01% or less, relative to the total mass of the composition. In some embodiments, the clear ink does not contain any coloring material. Pale inks and clear inks are similar in terms of being subject to discoloration and, accordingly, these inks are not strictly discriminated in the disclosed embodiments. However, the clear ink mentioned herein refers to an ink not containing a coloring material or containing a coloring material to the extent that it is not intended for coloring, and the pale ink mentioned herein refers to an ink containing a coloring material intended for coloring.

### 1. 1. 1. Pigment

A pigment used as the color material can enhance the light fastness of the radiation-curable ink jet composition. The pigment may be an inorganic pigment or an organic pigment. A pigment may be used independently, or two or more pigments may be used in combination.

Examples of the inorganic pigment include carbon blacks (C.I. (Color Index Generic Name) Pigment Black 7), such as furnace black, lamp black, acetylene black, and channel black, and iron oxide and titanium oxide.

Examples of the organic pigment include azo pigments, such as insoluble azo pigments, condensed azo pigments, azo lake, and chelate azo pigments; polycyclic pigments, such as phthalocyanine pigments, perylene and perinone pigments, anthraquinone pigments, quinacridone pigments, dioxane pigments, thioindigo pigments, isoindolinone pigments, and quinophthalone pigments; dye chelates, such as basic dye chelates and acid dye chelates; dye lakes, such as basic dye lakes and acid dye lakes; and nitro pigments, nitroso pigments, aniline black, and daylight fluorescent pigments.

More specifically, exemplary carbon blacks that can be used for black hues include No. 2300, No. 900, MCF 88, No. 33, No. 40, No. 45, No. 52, MA7, MA8, MA100, and No. 2200B (all produced by Mitsubishi Chemical Corporation); Raven 5750, Raven 5250, Raven 5000, Raven 3500, Raven 1255, and Raven 700 (all produced by Carbon Columbia); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all produced by Cabot); and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all produced by Degussa).

Pigments that can be used for white hues include C.I. Pigment Whites 6, 18, and 21.

Pigments that can be used for yellow hues include C.I. Pigment Yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

Magenta pigments that can be used for magenta hues include C.I. Pigment Reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48 (Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245; and C.I. Pigment Violets 19, 23, 32, 33, 36, 38, 43, and 50.

Pigments that can be used for cyan hues include C.I. Pigment Blues 1, 2, 3, 15, 15:1, 15:2, 15:3, 15:34, 15:4, 16, 18, 22, 25, 60, 65, and 66; and C.I. Violet Blues 4 and 60.

Pigments other than magenta, yellow, cyan, and yellow pigments may be used, and examples thereof include C.I. Pigment Greens 7 and 10, C.I. Pigment Browns 3, 5, 25, and 26, and C.I. Pigment Oranges 1, 2, 5, 7, 13, 14, 15, 16, 24, 34, 36, 38, 40, 43, and 63.

### 1. 1. 2. Dye

A dye may be used as the coloring material. The dye may be, but is not limited to, an acid dye, a direct dye, a reactive dye, or a basic dye. These dyes may be used individually or in combination.

Examples of the dye include, but are not limited to, C.I. Acid Yellows 17, 23, 42, 44, 79, and 142, C.I. Acid Reds 52, 80, 82, 249, 254, and 289, C.I. Acid Blues 9, 45, and 249, C.I. Acid Blacks 1, 2, 24, and 94, C.I. Food Blacks 1 and 2, C.I. Direct Yellows 1, 12, 24, 33, 50, 55, 58, 86, 132, 142, 144, and 173, C.I. Direct Reds 1, 4, 9, 80, 81, 225, and 227, C.I. Direct Blues 1, 2, 15, 71, 86, 87, 98, 165, 199, and 202, C.I. Direct Blacks 19, 38, 51, 71, 154, 168, 171, and 195, C.I. Reactive Reds 14, 32, 55, 79, and 249, and C.I. Reactive Blacks 3, 4, and 35.

### 1. 2. Polymerizable Compounds

The one or more polymerizable compounds include at least one of a monofunctional monomer having a nitrogen-containing heterocyclic structure and a monomer having a hydroxy group and may optionally include another monofunctional monomer or a bifunctional or higher functional monomer or oligomer (hereinafter referred to as a multifunctional monomer or oligomer). Such polymerizable compounds may be used individually or in combination.

### 1. 2. 1. Monofunctional Monomers

One or more monofunctional monomers may be used in a proportion of 86% or more, for example, 88% or more or 90% or more, relative to the total mass of the polymerizable compounds. When monofunctional monomers account for 86% or more of the total mass of the polymerizable compounds, the coating of the composition can be flexible and adhesive. The upper limit of the proportion of one or more monofunctional monomers may be, but is not limited to, 99% or less, for example, 98% or less or 97% or less, relative to the total mass of the polymerizable compounds. When monofunctional monomers account for 99% or less of the total mass of the polymerizable compounds, the coating of the composition tends to be resistant to rubbing.

Also, the monofunctional monomer content in the composition may be 60% or more, for example, 70% or more or 80% or more, relative to the total mass of the composition. The coating of the composition containing 60% by mass or more of monofunctional monomer(s) tends to be flexible and adhesive. The upper limit of the monofunctional monomer content may be 92% or less, for example, 90% or less or 88% or less, relative to the total mass of the composition. The coating of composition containing 90% or less of monofunctional monomer(s) tends to be resistant to rubbing.

### 1. 2. 1. 1. Monofunctional Monomer Having Nitrogen-Containing Heterocyclic Structure

Examples of the monofunctional monomer having a nitrogen-containing heterocyclic structure include, but are not limited to, N-vinylcaprolactam, N-vinylcarbazole, N-vinylpyrrolidone, and acryloylmorpholine. The nitrogen-containing heterocyclic structure is a structure having a heterocycle containing at least one nitrogen as a heteroatom.

In some embodiments, N-vinylcaprolactam or acryloylmorpholine may be used as the monofunctional monomer having a nitrogen-containing heterocyclic structure.

Such a monofunctional monomer having a nitrogen-containing heterocyclic structure is effective in forming coatings adhesive and resistant to rubbing. Also, monofunctional vinyl monomers having a nitrogen-containing heterocyclic structure, such as N-vinylcaprolactam, and monofunctional acrylate monomers having a nitrogen-containing heterocyclic structure, such as acryloylmorpholine, are effective in forming flexible and adhesive coatings.

Acryloylmorpholine and like monomers in which an electron-donating group, such as the alkyl group, is bound to a nitrogen atom are subject to abstraction of hydrogen from the electron-donating group by thioxanthone-based photopolymerization initiators. Therefore, the concept of the present disclosure is useful for compositions containing monomers such as acryloylmorpholine in which an electron-donating group, such as the alkyl group, is bound to a nitrogen atom.

The monofunctional monomer having a nitrogen-containing heterocyclic structure may be used in a proportion of 1% to 25%, for example, 5% to 20% or 5% to 15%, relative to the total mass of the polymerizable compounds. When the monofunctional monomer having a nitrogen-containing heterocyclic structure is used in such a proportion, the coating of the composition tends to be adhesive and resistant to rubbing.

The content of the monofunctional monomer having a nitrogen-containing heterocyclic structure may be 1% to 25%, for example, 2.0% to 20% or 3.0% to 15%, relative to the total mass of the composition. When the monofunctional monomer having a nitrogen-containing heterocyclic structure is used in such a proportion, the coating of the composition tends to be adhesive and resistant to rubbing.

### 1. 2. 1. 2. Monomer Having Hydroxy Group

Examples of the monomer having a hydroxy group (hereinafter often referred to as the hydroxy-containing monomer) include, but are not limited to, 4-hydroxybutyl (meth)acrylate, 2-hydroxybutyl (meth)acrylate, 2-hydroxyethyl (meth)acrylate, 2-hydroxyprppyl (meth)acrylate, 2-hydroxy-3-phenylpropyl (meth)acrylate, and N-hydroxymethyl (meth)acrylamide. Use of such a hydroxy-containing monomer increases the curability of the composition, and the coating of the composition tends to be hard.

The hydroxy-containing monomer may be used in a proportion of 0.5% to 10%, for example, 1% to 7.5% or 2% to 5.0%, relative to the total mass of the polymerizable compounds. When the hydroxy-containing monomer is used in such a proportion, the coating of the composition tends to be adhesive and resistant to rubbing.

The hydroxy-containing monomer content may be 0.5% to 10%, for example, 1% to 7.5% or 2% to 5.0%, relative to the total mass of the composition. When the hydroxy-containing monomer content is in such a range, the coating of the composition tends to be adhesive and resistant to rubbing.

### 1. 2. 1. 3. (Meth)Acrylate Having Crosslinked Condensed Ring Structure

Other monofunctional monomers may be used, and one example thereof is (meth)acrylate having a crosslinked condensed ring structure. The crosslinked condensed ring structure mentioned herein is a structure including two or more cyclic structures that share a side between two atoms on a one-to-one basis and in which two or more nonadjacent atoms of the same cyclic structure or different cyclic structures are crosslinked. Examples of such a (meth)acrylate having a crosslinked condensed ring structure include dicyclopentenyl (meth)acrylate, dicyclopentenyloxyethyl (meth)acrylate, and dicyclopentanyl (meth)acrylate. Other crosslinked condensed ring structures include the following:

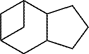

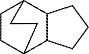 [SMILES: C1CC2C3CCC(CC3)C2C1]

In some embodiments, dicyclopentenyl (meth)acrylate may be used as one of the polymerizable compounds. Such a (meth)acrylate having a crosslinked condensed ring structure is effective in forming flexible and adhesive coatings resistant to rubbing.

The (meth)acrylate having a crosslinked condensed ring structure may be used in a proportion of 1% to 20%, for example, 3% to 15% or 5% to 10%, relative to the total mass of the polymerizable compounds. When the (meth)acrylate having a crosslinked condensed ring structure is used in such a proportion, the coating of the composition tends to be resistant to rubbing.

The (meth)acrylate having a crosslinked condensed ring structure may be used in a proportion of 1% to 20%, for example, 2% to 15% or 3% to 10%, relative to the total mass of the polymerizable compounds. When the (meth)acrylate having a crosslinked condensed ring structure is used in such a proportion, the coating of the composition tends to be resistant to rubbing.

### 1. 2. 1. 4. Monofunctional Monomers Having Aromatic Group

Another example of the other monofunctional monomers is monofunctional monomers having an aromatic group. Examples of the monofunctional monomers having an aromatic group include, but are not limited to, phenoxyethyl (meth)acrylate, benzyl (meth)acrylate, alkoxylated 2-phenoxyethyl (meth)acrylate, ethoxylated nonylphenyl (meth)acrylate, alkoxylated nonylphenyl (meth)acrylate, and EO-modified p-cumylphenol (meth)acrylate.

Phenoxyethyl (meth)acrylate and benzyl (meth)acrylate are beneficial. In some embodiments, phenoxyethyl (meth)acrylate, particularly phenoxyethyl acrylate (PEA), may be used. Such a monofunctional monomer having an aromatic group increases the solubility of the photopolymerization initiator and facilitate the curing of the composition. In particular, the solubility of acylphosphine oxide-based photopolymerization initiators and thioxanthone-based photopolymerization initiators tends to be increased.

The monofunctional monomer having an aromatic group may be used in a proportion of 25% to 60%, for example, 30% to 55% or 35% to 50%, relative to the total mass of the polymerizable compounds. When the monofunctional monomer having an aromatic group is used in such a proportion, the coating of the composition tends to be resistant to rubbing.

The content of the monofunctional monomer having an aromatic group may be 20% to 55%, for example, 25% to 50% or 30% to 45%, relative to the total mass of the composition. When the content of the monofunctional monomer having an aromatic group is in such a range, the coating of the composition tends to be resistant to rubbing.

### 1. 2. 1. 5. Monofunctional Urethane (Meth)Acrylate

Still another example of the other monofunctional monomers is monofunctional urethane (meth)acrylate. The monofunctional urethane (meth)acrylate may be, but is not limited to, an aliphatic urethane (math)acrylate or an aromatic urethane (meth)acrylate.

The aliphatic urethane (meth)acrylate may be represented by the following formula (1):

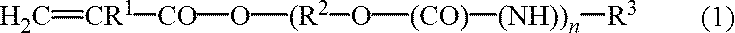

wherein R¹ represents a hydrogen atom or a methyl group, R² represents a divalent organic residue having a carbon number of 2 to 5, R³ represents an alkyl group having a carbon number of 1 to 10 or a hydroxyalkyl group having a carbon number of 1 to 10, and n represents an integer of 1 or more. Such a monofunctional (meth)urethane acrylate is effective in forming flexible and adhesive coatings.

The divalent organic group represented by R² in formula (1) having a carbon number of 2 to 5 may be, but is not limited to, an alkylene group, such as ethylene, n-propylene, isopropylene, or butylene. Examples of the alkyl group represented by R³ in formula (1) having a carbon number of 1 to 10 include, but are not limited to, methyl, ethyl, n-propyl, isopropyl, n-butyl, isobutyl, sec-butyl, t-butyl, n-pentyl, neopentyl, and n-hexyl. The hydroxyalkyl group represented by R³ in formula (1) having a carbon number of 1 to 10 may be, but is not limited to, a group formed by substituting a hydroxy group for a hydrogen atom of any of the above-cited alkyl groups.

Examples of the aliphatic urethane (meth)acrylate include, but are not limited to, 2-(butylcarbamoyloxy)ethyl (meth)acrylate, 2-(butylcarbamoyloxy)propyl (meth)acrylate, 4-(butylcarbamoyloxy)butyl (meth)acrylate, 2-(isopropylcarbamoyloxy)ethyl (meth)acrylate, 2-(isopropylcarbamoyloxy)propyl (meth)acrylate, and 4-(isopropylcarbamoyloxy)butyl (meth)acrylate.

Examples of the aromatic urethan (meth)acrylate include, but are not limited to, 2-(phenylcarbamoyloxy)ethyl (meth)acrylate, 2-(phenylcarbamoyloxy)propyl (meth)acrylate, 4-(phenylcarbamoyloxy)butyl (meth)acrylate, 2-(benzylcarbamoyloxy)ethyl (meth)acrylate, 2-(benzylcarbamoyloxy)propyl (meth)acrylate, and 4-(benzylcarbamoyloxy)butyl (meth)acrylate.

Aliphatic urethane (meth)acrylates are more beneficial, and, in some embodiments, 2-(butylcarbamoyloxy)ethyl (meth)acrylate may be used. Monofunctional urethane (meth)acrylates described above are effective in forming flexible and adhesive coatings.

The monofunctional urethane (meth)acrylate may be used in a proportion of 0.5% to 6%, for example, 1% to 5% or 2% to 4%, relative to the total mass of the polymerizable compounds. When the monofunctional urethane acrylate is used in such a proportion, the coating of the composition tends be flexible and adhesive.

The monofunctional urethane (meth)acrylate content may be 0.5% to 6%, for example, 1% to 5% or 2% to 4%, relative to the total mass of the composition. When the monofunctional urethane (meth)acrylate content is in such a range, the coating of the composition tends be flexible and adhesive.

### 1. 2. 1. 6. (Meth)acrylate Having Alicyclic Structure

A further example of the other monofunctional monomers is (meth)acrylate having an alicyclic structure. The (meth)acrylate having an alicyclic structure used herein has at least one alicyclic group in the molecular structure and no crosslinked condensed ring structure.

The alicyclic group may be substituted by an alkyl group having a carbon number of 1 to 10, a hydroxy group, an aryl group having a carbon number of 6 to 16, or the like

The alicyclic group may be bound to an oxygen atom of the (meth)acryloyl group directly or with an alkylene group or the like having a carbon number of 1 to 10 therebetween.

The alkylene group may be substituted by an alkyl group having a carbon number of 1 to 10, a hydroxy group, an aryl group or the like having a carbon number of 6 to 16 and may have an ester bond or an ether bond in the main chain thereof.

The number of atoms forming the ring of the alicyclic group may be, but is not limited to, 3 to 20, for example, 5 to 12.

Examples of the (meth)acrylate having an alicyclic structure include, but are not limited to, isobornyl (meth)acrylate, cyclohexyl (meth)acrylate, tert-butylcyclohexyl (meth)acrylate, and 3,3,5-trimethylcyclohexyl (meth)acrylate. In some embodiments, isobornyl (meth)acrylate may be used.

The content of the (meth)acrylate having an alicyclic structure may be 3.0% to 60.0%, for example, 5.0% to 50.0% or 10.0% to 30.0%, relative to the total mass of the composition.

When the content of the (meth)acrylate having an alicyclic structure is in such a range, the coating of the composition tends to be resistant to rubbing.

### 1. 2. 2. Multifunctional Monomer or Oligomer

A multifunctional monomer or oligomer may be used in a proportion of 1% to 20%, for example, 3% to 17.5% or 6% to 15%, relative to the total mass of the polymerizable compounds. When the multifunctional monomer or oligomer accounts for 2.5% or more of the total mass of the polymerizable compounds, the coating of the composition tends to be resistant to rubbing. Also, when the multifunctional monomer or oligomer accounts for 20% or less of the total mass of the polymerizable compounds, the coating of the composition tends to be flexible and adhesive. The multifunctional monomer or oligomer may be bifunctional to hexafunctional. In some embodiments, a bifunctional or trifunctional monomer may be used. Bifunctional monomers are more beneficial. Although multifunctional monomers generally tend to be viscous, the composition containing such a multifunctional monomer can have a low viscosity and a high curability.

The multifunctional monomer content may be 1% to 20%, for example, 3% to 17.5% or 6% to 15%, relative to the total mass of the composition. When the multifunctional monomer content is 2.5% or more relative to the total mass of the composition, the coating of the composition tends to be resistant to rubbing. Also, when the multifunctional monomer content is 20% or less relative to the total mass of the composition, the coating of the composition tends to be flexible and adhesive.

### 1. 2. 2. 1. Vinyl Ether-Containing (Meth)Acrylic Ester

One example of the multifunctional monomer is vinyl ether-containing (meth)acrylic acid esters. The vinyl ether-containing (meth)acrylic esters include, but are not limited to, the compounds represented by the following formula (2):

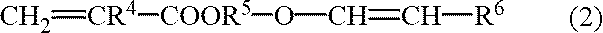

wherein R⁴ represents a hydrogen atom or a methyl group, R⁵ represents a divalent organic residue having a carbon number of 2 to 20, and R⁶ represents a hydrogen atom or a monovalent organic residue having a carbon number of 1 to 11. Such vinyl ether-containing (meth) acrylic esters are effective in reducing the viscosity of the composition and increasing the ejection consistency and curability of the composition.

In formula (2), the divalent organic residue represented by R⁵ having a carbon number of 2 to 20 may be a substituted or unsubstituted linear, branched, or cyclic alkylene group having a carbon number of 2 to 20, a substituted or unsubstituted alkylene group having a carbon number of 2 to 20 and having an oxygen atom of an ether bond and/or an ester bond in the molecular structure thereof, or a substituted or unsubstituted divalent aromatic group having a carbon number of 6 to 11. Beneficially, R⁵ may be an alkylene group having a carbon number of 2 to 6, such as ethylene, n-propylene, isopropylene, or butylene; or an alkylene group having a carbon number of 2 to 9 and having an oxygen atom of an ether bond in the molecular structure, such as oxyethylene, oxy n-propylene, oxyisopropylene, or oxybutylene. In some embodiments, R⁵ may be an alkylene group having a carbon number of 2 to 9 and having an oxygen atom of an ether bond in the molecular structure, such as oxyethylene, oxy n-propylene, oxyisopropylene, or oxybutylene from the viewpoint of further reducing the viscosity of the composition and further increasing the curability of the composition.

In formula (2), the monovalent organic residue represented by R⁶ having a carbon number of 1 to 11 may be a substituted or unsubstituted linear, branched, or cyclic alkyl group having a carbon number of 1 to 10 or a substituted or unsubstituted aromatic group having a carbon number of 6 to 11. Beneficially, R⁶ may be an alkyl group having a carbon number of 1 or 2, that is, methyl or ethyl, or an aromatic group having a carbon number of 6 to 8, such as phenyl or benzyl.

If the organic residues are substituted, the substituent may or may not contain one or more carbon atoms. For the substituent containing one or more carbon atoms, these carbon atoms are counted in the carbon number of the organic residue. Examples of the substituent containing one or more carbon atoms include, but are not limited to, carboxy and alkoxy. Examples of the substituent not containing carbon atoms include, but are not limited to, hydroxy and halogens.

Examples of the compound represented by formula (2) include, but are not limited to, 2-vinyloxyethyl (meth)acrylate, 3-vinyloxypropyl (meth)acrylate, 1-methyl-2-vinyloxyethyl (meth)acrylate, 2-vinyloxypropyl (meth)acrylate, 4-vinyloxybutyl (meth)acrylate, 1-methyl-3-vinyloxypropyl (meth)acrylate, 1-vinyloxymethylpropyl (meth)acrylate, 2-methyl-3-vinyloxypropyl (meth)acrylate, 1,1-dimethyl-2-vinyloxyethyl (meth)acrylate, 3-vinyloxybutyl (meth)acrylate, 1-methyl-2-vinyloxypropyl (meth)acrylate, 2-vinyloxybutyl (meth)acrylate, 4-vinyloxycyclohexyl (meth)acrylate, 6-vinyloxyhexyl (meth)acrylate, 4-vinyloxymethylcyclohexylmethyl (meth)acrylate, 3-vinyloxymethylcyclohexylmethyl (meth)acrylate, 2-vinyloxymethylcyclohexylmethyl (meth)acrylate, p-vinyloxymethylphenylmethyl (meth)acrylate, m-vinyloxymethylphenylmethyl (meth)acrylate, o-vinyloxymethylphenylmethyl (meth)acrylate, 2-(2-vinyloxyethoxy)ethyl (meth)acrylate, 2-(vinyloxyisopropoxy)ethyl (meth)acrylate, 2-(vinyloxyethoxy)propyl (meth)acrylate, 2-(vinyloxyethoxy)isopropyl (meth)acrylate, 2-(vinyloxyisopropoxy)propyl (meth)acrylate, 2-(vinyloxyisopropoxy)isopropyl (meth)acrylate, 2-(vinyloxyethoxyethoxy)ethyl (meth)acrylate, 2-(vinyloxyethoxyisopropoxy)ethyl (meth)acrylate, 2-(vinyloxyisopropoxyethoxy)ethyl (meth)acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy)isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth)acrylate, 2-(vinyloxyethoxyethoxyethoxy)ethyl (meth)acrylate, 2-(vinyloxyethoxyethoxyethoxyethoxy)ethyl (meth)acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth)acrylate, polyethylene glycol monovinyl ether (meth)acrylate, and polypropylene glycol monovinyl ether (meth)acrylate. Among these examples, 2-(2-vinyloxyethoxy)ethyl acrylate is beneficial in terms of the balance between the curability and the viscosity of the composition. In the following description, 2-(2-vinyloxyethoxy)ethyl acrylate may be often abbreviated to VEEA.

The vinyl ether-containing (meth)acrylic ester may be used in a proportion of 0.5% to 10%, for example, 1% to 7.5% or 2% to 5%, relative to the total mass of the polymerizable compounds. When the vinyl ether-containing (meth) acrylic ester is used in such a proportion, the composition tends to have a low viscosity and, accordingly, can be consistently ejected.

The vinyl ether-containing (meth)acrylic ester content may be 1.0% to 10%, for example, 1.0% to 7.5% or 2.0% to 5%, relative to the total mass of the composition. When the vinyl ether-containing (meth) acrylic ester content is in such a range, the composition tends to have a low viscosity and, accordingly, can be consistently ejected.

### 1. 2. 2. 2. Urethane Acrylate Oligomer

One example of the multifunctional oligomer is urethane acrylate oligomers. Exemplary urethane acrylate oligomers include, but are not limited to, aliphatic urethane acrylate oligomers and aromatic urethane acrylate oligomers. If a urethane acrylate oligomer is used, tetrafunctional or lower functional urethane acrylate oligomers are beneficial. In some embodiments, a bifunctional urethane acrylate oligomer may be used. Such oligomers are effective in improving the storage stability of the composition and increasing the rub resistance of the coating. In the present disclosure, oligomers are defined as compounds having a molecular weight of 1000 or more, while monomers are defined as compounds having a molecular weight of less than 1000.

The urethane acrylate oligomer may be used in a proportion of 1% to 10%, for example, 2% to 9% or 3% to 7%, relative to the total mass of the polymerizable compounds. When the urethane acrylate oligomer is used in such a proportion, the composition tends to be stably preserved, and the coating of the composition tends to be resistant to rubbing.

The urethane acrylate oligomer content may be 1% to 10%, for example, 2% to 9% or 3% to 7%, relative to the total mass of the composition. When the urethane acrylate oligomer content is in such a range, the composition tends to be stably preserved, and the coating of the composition tends to be resistant to rubbing.

### 1. 3. Photopolymerization Initiator

In some embodiments, the radiation-curable ink jet composition may contain a photopolymerization initiator that produces an active species when being irradiated with radiation. A photopolymerization initiator may be used independently, or some photopolymerization initiators may be used in combination.

Known photopolymerization initiators can be used, and examples thereof include, but are not limited to, acylphosphine oxide-based photopolymerization initiators, alkylphenone-based photopolymerization initiators, titanocene-based photopolymerization initiators, and thioxanthone-based photopolymerization initiators. Acylphosphine oxide-based photopolymerization initiators are more beneficial. Use of such a photopolymerization initiator tends to increase the curability of the composition. The composition containing such a photopolymerization initiator can be more favorably cured by irradiation particularly with light from a UV-LED.

Exemplary acylphosphine oxide-based photopolymerization initiators include, but are not limited to, 2,4,6-trimethylbenzoyldiphenylphosphine oxide, bis(2,4,6-trimethylbenzoyl)phenylphosphine oxide, and bis(2,6-dimethoxybenzoyl)-2,4,4-trimethylpentylphosphine oxide.

Some acylphosphine oxide-based photopolymerization initiators are commercially available, and examples thereof include IRGACURE 819 (bis(2,4,6-trimethylbenzoyl)phenylphosphine oxide, IRGACURE 1800 (mixture of bis(2,6-dimethoxybenzoyl)-2,4,4-trimethylpentylphosphine oxide and 1-hydroxycyclohexyl phenyl ketone with a mass ratio of 25:75), and IRGACURE TPO (2,4,6-trimethylbenzoylphenylphosphine oxide), all produced by BASF.

The acylphosphine oxide-based photopolymerization initiator content may be 20% or less, for example, 15% or less or 10% or less, relative to the total mass of the composition. By controlling the acylphosphine oxide-based photopolymerization initiator content to 20% or less, the effect of the hue of this photopolymerization initiator can be reduced. Accordingly, the composition can exhibit satisfactory color reproduction. The acylphosphine oxide-based photopolymerization initiator content may be 1% or more, for example, 3% or more or 5% or more, relative to the total mass of the composition. When the acylphosphine oxide-based photopolymerization initiator content is in such a range, the composition tends to be satisfactorily curable and unlikely to discolor (resistant to discoloration).

In addition, the thioxanthone-based photopolymerization initiator content may be 0.3% or less, for example, 0.25% or less or 0.20% or less, relative to the total mass of the radiation-curable ink jet composition. From the viewpoint of suppressing discoloration, the thioxanthone-based photopolymerization initiator content may be as close to as 0% by mass. In some embodiments, the composition does not contain any thioxanthone-based photopolymerization initiator. However, from the viewpoint of reducing oxygen inhibition to increase the curability of the composition, the lower limit of the thioxanthone-based photopolymerization initiator content may be set to 0.01% by mass or more or 0.05% by mass or more.

The thioxanthone-based photopolymerization initiator is commercially available, and examples thereof include KAYACURE DETX-S (produced by Nippon Kayaku), ITX (produced by BASF), and Quantacure CTX (produced by Aceto Chemical).

The content of photopolymerization initiators other than the thioxanthone-based photopolymerization initiator may be 1% to 20%, for example, 3% to 15%, 5% to 10%, or 7% to 9%, relative to the total mass of the composition. When the content of photopolymerization initiators other than the thioxanthone-based photopolymerization initiator is in such a range, the composition tends to be satisfactorily curable and unlikely to discolor.

### 1. 3. Other Constituents

The radiation-curable ink composition disclosed herein may optionally contain other constituents as additives, such as a dispersant, a polymerization inhibitor, and a slipping agent.

### 1. 3. 1. Dispersant

For an ink jet composition containing a pigment, a dispersant may be added so that the pigment can be sufficiently dispersed. A dispersant may be used independently, or two or more dispersants may be used in combination.

The dispersant may be, but is not limited to, a polymer dispersant or the like that is conventionally used for preparing pigment dispersion liquids. Examples of such a polymer dispersant include polyoxyalkylene polyalkylene polyamines, vinyl polymers and copolymers, acrylic polymers and copolymers, polyesters, polyamides, polyimides, polyurethanes, amino polymers, silicon-containing polymers, sulfur-containing polymers, fluorine-containing polymers, and epoxy resins. The polymer dispersant may contain at least one of these polymers as the main constituent.

The polymer dispersant is commercially available, and examples thereof include AJISPER series produced by Ajinomoto Fine-Techno, Solsperse series, such as Solsperse 36000, available from Avecia or Noveon, Disper BYK series produced by BYK Additives & Instruments, and DISPARLON series produced by Kusumoto Chemicals.

The dispersant content in the composition may be 0.1% to 2%, for example, 0.1% to 1% or 0.1% to 0.5%, relative to the total mass of the composition.

### 1. 3. 3. Polymerization Inhibitor

The radiation-curable ink jet composition disclosed herein may further contain a polymerization inhibitor. A polymerization inhibitor may be used independently, or two or more polymerization inhibitors may be used in combination.

Examples of the polymerization inhibitor include, but are not limited to, p-methoxyphenol, hydroquinone monomethyl ether (MEHQ), 4-hydroxy-2,2,6,6-tetramethylpiperidine-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), 4,4′-thiobis(3-methyl-6-t-butylphenol), and hindered amine compounds.

The polymerization inhibitor content in the composition may be 0.05% to 1%, for example, 0.05% to 0.5%, relative to the total mass of the composition.

### 1. 3. 4. Slipping Agent

The radiation-curable ink jet composition disclosed herein may further contain a slipping agent. A slipping agent may be used independently, or two or more slipping agents may be used in combination.

The slipping agent may be a silicone surfactant. In some embodiments, a polyester-modified silicone or a polyether-modified silicone may be used. Examples of the polyester-modified silicone include BYK-347, BYK-348, BYK-UV 3500, BYK-UV 3510, and BYK-UV 3530 (all produced by BYK Additives & Instruments). The polyether-modified silicone may be BYK-3570 (produced by BYK Additives & Instruments).

The slipping agent content in the composition may be 0.01% to 2%, for example, 0.05% to 1%, relative to the total mass of the composition.

### 1. 4. Preparation of the Composition

The radiation-curable ink jet composition can be prepared by mixing the constituents and sufficiently stirring the constituents to the extent that the mixture becomes uniform. In the preparation of the composition of an embodiment, a mixture of the photopolymerization initiator and the entirety or a portion of the monomers may be subjected to at least either ultrasonic treatment or heating. Such treatment can reduce dissolved oxygen in the composition, so that the composition can be consistently ejected and stably preserved. The mixture may further contain all or some of the other constituents of the composition, in addition to the photopolymerization initiator and at least a portion of the monomers. The monomers in the mixture may be a portion of the monomers to be added to the radiation-curable ink jet composition.

### 2. Ink Jet Printing Method

The printing method according to the embodiments of the present disclosure includes an ejection step of ejecting the above-described radiation-curable ink jet composition from an ink jet head to apply the composition onto a printing medium, and an irradiation step of irradiating the radiation-curable ink jet composition on the printing medium with radiation. Thus, the radiation-curable ink jet composition on the printing medium forms a coating over the area to which the composition is applied. Major steps of the method will now be described.

### 2. 1. Ejection Step

In the ejection step, the composition is ejected from an ink jet head to be applied onto a printing medium. More specifically, the composition in a pressure generating chamber of the ink jet head may be ejected through nozzles by the operation of a pressure-generating device. Such a method for ejection is often referred to as an ink jet method.

The ink jet head used in the ejection step may be a line head used for line printing or a serial head used for serial printing.

For line printing with a line head, for example, an ink jet head having a width more than or equal to the width of the printing medium is fixed to the printing apparatus. While the printing medium is moved to be fed in a subscanning direction (transport direction, the longitudinal direction of the printing medium), ink droplets are ejected through the nozzles of the ink jet head in conjunction with the movement of the printing medium. Images are thus printed on the printing medium.

For serial printing with a serial head, an ink jet head is mounted on a carriage capable of moving across the width of the printing medium. While the carriage is moved in the main scanning direction (the lateral direction of the printing medium, width direction), the head ejects ink droplets through the nozzles in conjunction with the movement of the carriage. Images are thus printed on the printing medium.

### 2. 2. Irradiation Step

In the irradiation step, the radiation-curable ink jet composition on the printing medium is irradiated with radiation. When the composition is irradiated with radiation, the monomers start a polymerization reaction to cure the composition, thus forming a coating. If a polymerization initiator is present at this time, the photopolymerization initiator produces an active species (initiation species), such as a radical, an acid, or a base, and the polymerization reaction of the monomers is promoted by the function of the active species.

Radiation may be ultraviolet (UV) light, infrared (IR) light, visible light, or X rays. The radiation is emitted from a radiation source disposed downstream from the ink jet head. The radiation source may be, but is not limited to, a UV-LED. Use of such a radiation source can reduce the size and cost of the apparatus. The UV-LED, which is a small UV radiation source, can be incorporated into the ink jet printing apparatus.

For example, the UV-LED may be attached to the carriage on which the ink jet head to eject the radiation composition is mounted (on both ends of the carriage in the direction parallel to the width of the printing medium and/or on a side of the carriage in the medium transport direction). The radiation-curable ink jet composition thus can be rapidly cured at a low energy level. The irradiation energy is calculated by multiplying irradiation time by irradiation intensity. Therefore, the irradiation time can be reduced, and the printing speed can be increased. Also, the irradiation intensity can be reduced. Thus, temperature increase of the printed item can be reduced, and accordingly, the odor of the cured coating can be reduced.

### 3. Recorded Item

Printed items mentioned herein are media printed with the radiation-curable ink jet composition applied thereto and cured thereon. Since the composition disclosed herein is flexible and adhesive, the printed item can be cut out or bent without cracking or chipping the coating. Accordingly, the printed item using the composition disclosed herein is suitable for advertisement signs or the like.

Exemplary materials of the printing medium include, but are not limited to, plastics, such as polyvinyl chloride, polyethylene terephthalate, polypropylene, polyethylene, polycarbonate, cellulose diacetate, cellulose triacetate, cellulose propionate, cellulose butyrate, cellulose acetate butyrate, cellulose nitrate, polystyrene, and polyvinyl acetal, glass, paper, metals, and wood. Surface-treated plastics may be used.

The printing medium may be in any form without particular limitation. For example, the printing medium may be in the form of a film, a board, or a cloth.

### EXAMPLES

The subject matter of the present disclosure will be further described in detail with reference to Examples. However, the implementation of the concept of the present disclosure is not limited to the following Examples.

### 1. Preparation of Ink Jet Compositions

First, a coloring material, a dispersant, and a portion of each monomer were added into a pigment dispersing tank and stirred with ceramic beads of 1 mm in diameter to yield a pigment dispersion liquid in which the coloring material was dispersed in the polymerizable compounds. Then, the rest of the monomers, polymerization initiators, and a polymerization inhibitor were added into a stainless-steel mixing tank according to the composition presented in the Table, and the contents in the tank were completely dissolved by stirring. Into the resulting solution, the pigment dispersion liquid was added, followed by stirring at room temperature for 1 hour. The mixture was then filtered through a membrane filter of 5 µm in pore size. Thus, ink jet compositions of some Examples were prepared.

For the compositions not containing a coloring material, the constituents were added into a stainless-steel mixing tank according to the composition presented in the Table. The contents in the mixing tank, not containing the pigment dispersion liquid, were stirred. Thus the radiation-curable ink jet compositions of some Examples were prepared.

The values of the constituents presented in the Table are represented by mass percent.

TABLE 1

| | | Example | | | | | | | | | | | | Comparative Example | | | Reference Example |
|---|---|---|---|---|---|---|---|---|---|---|---|---|---|---|---|---|---|
| | | 1 | 2 | 3 | 4 | 5 | 6 | 7 | 8 | 9 | 10 | 11 | 12 | 1 | 2 | 3 | 1 |
| Coloring material | PB15:3 | 0 | 0 | 0 | 0 | 0 | 0.5 | 1.1 | 0 | 0 | 0 | 0 | 0 | 0 | 0 | 0 | 1.5 |
| | Titanium oxide | 0 | 0 | 0 | 0 | 0 | 0 | 0 | 18 | 0 | 0 | 0 | 0 | 0 | 0 | 0 | 0 |
| Photopolymerization initiator | DETX | 0 | 0.25 | 0 | 0 | 0 | 0.25 | 0.25 | 0.25 | 0 | 0.25 | 0.25 | 0.1 | 0.5 | 0.25 | 0.5 | 0.25 |
| | 819 | 3 | 3 | 3 | 3 | 3 | 3 | 3 | 5 | 6 | 3 | 3 | 3 | 3 | 3 | 3 | 3 |
| | TPO | 5 | 5 | 5 | 5 | 5 | 5 | 5 | 5 | 5 | 5 | 5 | 5 | 5 | 5 | 5 | 5 |
| Polymerizable compound | ACMO | 10 | 10 | 3 | 15 | 0 | 10 | 10 | 10 | 10 | 20 | 0 | 0 | 10 | 0 | 0 | 10 |
| | n-VC | 0 | 0 | 0 | 0 | 0 | 0 | 0 | 0 | 0 | 0 | 10 | 10 | 0 | 0 | 0 | 0 |
| | 4-HBA | 0 | 0 | 0 | 0 | 3 | 0 | 0 | 0 | 0 | 0 | 0 | 0 | 0 | 0 | 0 | 0 |
| | DCPA | 5 | 5 | 5 | 5 | 15 | 5 | 5 | 5 | 5 | 5 | 5 | 5 | 5 | 5 | 5 | 5 |
| | IBXA | 25 | 25 | 25 | 25 | 25 | 25 | 25 | 25 | 25 | 25 | 25 | 25 | 25 | 25 | 25 | 25 |
| | PEA | 40.2 | 39.9 | 47.2 | 35.2 | 37.2 | 39.4 | 38.8 | 19.9 | 37.2 | 29.9 | 39.9 | 40.1 | 39.7 | 49.9 | 49.7 | 38.4 |
| | BCEA | 3 | 3 | 3 | 3 | 3 | 3 | 3 | 3 | 3 | 3 | 3 | 3 | 3 | 3 | 3 | 3 |
| | VEEA | 3 | 3 | 3 | 3 | 3 | 3 | 3 | 3 | 3 | 3 | 3 | 3 | 3 | 3 | 3 | 3 |
| | CN991 | 5 | 5 | 5 | 5 | 5 | 5 | 5 | 5 | 5 | 5 | 5 | 5 | 5 | 5 | 5 | 5 |
| Percentage of polymerizable compounds to monofunctional monomers | | 91.2 | 91.2 | 912 | 91.2 | 91.2 | 912 | 91.1 | 88.7 | 90.9 | 91.2 | 91.2 | 91.2 | 91.2 | 91.2 | 91.2 | 91.1 |
| Polymerization inhibitor | MEHQ | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Slipping agent | UV3500 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Dispersant | solsperse36000 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 |
| Total | | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 | 100.0 |
| Evaluated property | Discoloration resistance | A | B | A | A | A | B | A | B | C | C | B | A | D | A | A | A |
| | Adhesion | B | A | B | B | B | A | A | C | A | A | A | A | A | A | A | B |
| | Rub resistance | B | B | C | A | B | B | B | B | B | A | B | B | B | D | D | B |

The abbreviations and materials of the constituents of the compositions presented in the Table are as follows. Coloring Materials (Pigments):
PB15:3 (Phthalocyanine Blue available as C.I. Pigment Blue 15:3 (product name) produced by DIC)
Titanium oxide (C.I. Pigment White 6 (product name) produced by produced by Tayca)

Photopolymerization Initiators:
DETX (2,4-diethylthioxanthone available as KAYACURE DETX-S (product name) produced by Nippon Kayaku)
819 (bis(2,4,6-trimethylbenzoyl)phenylphosphine oxide available as IRGACURE 819 (product name) produced by BASF)
TPO (2,4,6-trimethylbenzoyldiphenylphosphine oxide available as IRGACURE TPO (product name) produced by BASF) Monofunctional Monomers:
ACMO (acryloylmorpholine, produced by KJ Chemicals)
n-VC (N-vinylcaprolactam, available from ISP Japan)
4-HBA (4-hydroxybutyl acrylate, monofunctional

(meth)acrylate, produced by Osaka Organic Chemical Industry)
DCPA (dicyclopentenyl acrylate, produced by Hitachi Chemical Company)
IBXA (isobornyl acrylate, produced by Osaka Organic Chemical Industry)
PEA (phenoxyethyl acrylate, available as Biscoat #192 (product name) produced by Osaka Organic Chemical Industry)
BCEA (2-(butylcarbamoyloxy)ethyl acrylate) Multifunctional Monomers:
VEEA (2-(2-vinyloxyethoxy)ethyl acrylate, produced by Nippon Shokubai) Oligomer
CN991 (bifunctional urethane acrylate oligomer, produced by Sartomer)

Polymerization Inhibitor:
MEHQ (hydroquinone monomethyl ether available as p-Methoxyphenol (product name) produced by Kanto Chemical) Slipping Agent:
BYK-UV 3500 (acryloyl group-containing polyether-modified polydimethylsiloxane produced by BYK Additives & Instruments)

Dispersant:
Solsperse 36000 (polymer dispersant produced by Lubrizol)

### 2. Evaluation

### 2. 1. Discoloration Resistance

The composition was applied onto a PVC printing medium with a bar coater to form a 10 µm-thick coating. The coating was irradiated with UV light at an intensity of 2.5 W/cm² at the surface of the medium while at least either the medium or the light source was being moved relative to each other at a rate of 0.04 cm/s. The light source was an LED having a peak wavelength at 395 nm. The b* value of the coating immediately after being cured was measured with a colorimeter Gretag Macbeth Spectrolino (manufactured by X-RITE). Also, the b* value of the coating that had been allowed to stand for 24 hours after being cured was measured. The discoloration resistance of the coating was rated according to the following criteria based on the difference Δb* between the value immediately after curing and the value 24 hours after curing.

Criteria
A: Δb* was less than 1
B: Δb* was 1 to less than 2.
C: Δb* was 2 to less than 3.
D: Δb* was 3 or more.

### 2. 2. Adhesion

The coating formed for the discoloration test was subjected to cross-cut test in accordance with JIS K5600-5-6. More specifically, the blade of a box cutter was perpendicularly put to the coating, and a 10 x 10 grid was formed with cut lines spaced 2 mm apart. A 25 mm-wide transparent adhesive tape of about 75 mm in length was stuck over the grid and sufficiently rubbed with a finger so that the coating could be seen through the tape. Then, within 5 minutes after sticking the tape, the tape was removed from the coating for 0.5 s to 1.0 s at an angle of about 60°, and the grid was visually observed. The rating criteria were as follows.

Criteria
A: The coating was not peeled from any segments of the grid.
B: The coating was peeled from less than 5% of the segments of the grid.
C: The coating was peeled from 5% or more of the segments of the grid.

### 2. 3. Rub Resistance

The coating formed for the discoloration test was subjected to micro scratch test in accordance with JIS R3255. The rub resistance of the coating was estimated by measuring withstand load with an ultrathin film scratch tester CSR-5000 (manufactured by Nanotech Corporation). More specifically, the coating was scratched at varying loads, and the load when the stylus of the tester came into contact with the surface of the medium was defined as the withstand load. The higher the withstand load, the higher the rub resistance. The measurement conditions were 15 µm in stylus diameter, 100 µm in swing width, and 10 µm/s in scratch speed. The rating criteria were as follows.

Criteria
A: 25 mN/cm² or more
B: 20 mN/cm² to less than 25 mN/cm²
C: 15 mN/cm² to less than 20 mN/cm²
D: less than 15 mN/cm²

Each of the radiation-curable ink jet compositions was introduced into an ink jet printer PX-G930 (manufactured by Seiko Epson) for a printing test. All the radiation-curable ink jet compositions were able to be ejected to form an image.

### 3. Evaluation Results

The Table presents the constituents and their proportions of the radiation-curable ink jet compositions of the Examples, Comparative Examples, and Reference Example and evaluation results for the compositions. The Table shows that all the radiation-curable ink jet compositions of Examples 1 to 12 were rated as C or better in terms of discoloration resistance, adhesion, and rub resistance. The compositions of these Examples contained at least one polymerizable compound including at least either a monofunctional monomer having a nitrogen-containing heterocyclic structure or a monomer having a hydroxy group, but in which the thioxanthone-based photopolymerization initiator content was limited to 0.3% or less relative to the total mass of the radiation-curable ink jet composition.

More specifically, the comparisons between each Example and Comparative Example 1 suggest that when the thioxanthone-based photopolymerization initiator content is 0.3% by mass or less, the composition is more resistant to discoloration. The comparisons between each Example and Comparative Example 2 suggest that the compositions containing a monofunctional monomer having a nitrogen-containing heterocyclic structure or a monomer having a hydroxy group are more resistant to rubbing. The comparisons between each Example and Comparative Example 3 suggest that the composition not containing a monofunctional monomer having a nitrogen-containing heterocyclic structure or a monomer having a hydroxy group is not discolored by the thioxanthone-based photopolymerization initiator. Also, the comparisons between each Example and the Reference Example suggest that when the coloring material content is more than 1.2% by mass, the thioxanthone-based photopolymerization initiator does not much affect the hue of the coating.

What is claimed is:

1. A radiation-curable ink jet composition that is clear ink, the radiation-curable ink jet composition comprising:
at least one polymerizable compound including a monofunctional monomer having a nitrogen-containing heterocyclic structure,
wherein a content of the monofunctional monomer having the nitrogen-containing heterocyclic structure is 1 to 25 % relative to a total mass of the radiation-curable ink jet composition,
the monofunctional monomer having the nitrogen-containing heterocyclic structure includes a monofunctional acrylate monomer having a nitrogen-containing heterocyclic structure,
the radiation-curable ink jet composition is an ink composition configured to form an image on a printing medium, and
a content of a thioxanthone-based photopolymerization initiator is 0.3% or less relative to the total mass of the radiation-curable ink jet composition.

2. The radiation-curable ink jet composition according to claim 1, further comprising an acylphosphine oxide-based photopolymerization initiator in a proportion of 10% or less relative to the total mass of the radiation-curable ink jet composition.

3. The radiation-curable ink jet composition according to claim 1, wherein the monofunctional monomer having the nitrogen-containing heterocyclic structure includes acryloylmorpholine.

4. The radiation-curable ink jet composition according to claim 1, wherein the content of the monofunctional monomer having the nitrogen-containing heterocyclic structure is 3.0% to 15% relative to the total mass of the radiation-curable ink jet composition.

5. The radiation-curable ink jet composition according to claim 1, wherein the at least one polymerizable compound includes a (meth)acrylate having a crosslinked condensed ring structure.

6. The radiation-curable ink jet composition according to claim 5, wherein the (meth)acrylate having the crosslinked condensed ring structure includes dicyclopentenyl (meth)acrylate.

7. The radiation-curable ink jet composition according to claim 1, wherein the at least one polymerizable compound includes a monofunctional urethane acrylate.

8. The radiation-curable ink jet composition according to claim 7, wherein the monofunctional urethane acrylate is represented by the following formula (1): 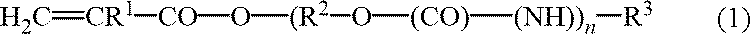
wherein R¹ represents a hydrogen atom or a methyl group, R² represents a divalent organic residue having a carbon number of 2 to 5, R³ represents an alkyl group having a carbon number of 1 to 10 or a hydroxyalkyl group having a carbon number of 1 to 10, and n represents an integer of 1 or more.

9. The radiation-curable ink jet composition according to claim 1, wherein the at least one polymerizable compound includes a (meth)acrylic ester having a vinyl ether group, represented by the following formula (2): 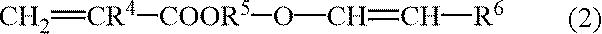
wherein R⁴ represents a hydrogen atom or a methyl group, R⁵ represents a divalent organic residue having a carbon number of 2 to 20, and R⁶ represents a hydrogen atom or a monovalent organic residue having a carbon number of 1 to 11, wherein
the (meth)acrylic ester content is 1.0% to 10% relative to the total mass of the radiation-curable ink jet composition.

10. The radiation-curable ink jet composition according to claim 1, wherein the at least one polymerizable compound includes at least one monofunctional monomer in a proportion of 90% or more relative to the total mass of the at least one polymerizable compound.

11. A printing method comprising:
an ejection step of ejecting the radiation-curable ink jet composition as set forth in claim 1 from an ink jet head to apply the radiation-curable ink jet composition onto the printing medium; and
an irradiation step of irradiating the radiation-curable ink jet composition on the printing medium with radiation.

12. The radiation-curable ink jet composition according to claim 1, wherein a content of the monofunctional acrylate monomer having the nitrogen-containing heterocyclic structure is 1 to 25% relative to the total mass of the radiation-curable ink jet composition.

13. The radiation-curable ink jet composition according to claim 1, wherein the polymerizable compound includes a bifunctional or higher functional monomer.
